(19) United States
(12) Patent Application Publication
(10) Pub. No.: US 2007/0073824 A1
(43) Pub. Date: Mar. 29, 2007

(54) Apparatus and method for acquiring identification information when a bus reset occurs

(75) Inventors: Joung-hoon Choo, Seoul (KR); Tae-yun An, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/433,575

(22) Filed: May 15, 2006

(30) Foreign Application Priority Data
Sep. 6, 2005 (KR) 10-2005-0082861

(51) Int. Cl. G06F 15/16

(52) U.S. Cl. 709/208

(57) ABSTRACT

An apparatus and a method for acquiring identification information when a bus reset occurs are provided. The apparatus and the method for acquiring identification information when a bus reset occurs to control a slave device without an error by acquiring the new identification information (e.g., a PHY ID) by adjusting the power state of a slave device when a bus reset occurs in slave devices existing in an IEEE 1394 A/V network, and to reduce the power consumption by changing the power state to the power-standby state after acquiring the basic information of the slave device.

### CROSS-REFERENCE TO RELATED APPLICATIONS

This application claims priority from Korean Patent Application No. 10-2005-0082861 filed on Sep. 6, 2005 in the Korean Intellectual Property Office, the disclosure of which is incorporated herein by reference in its entirety.

### BACKGROUND OF THE INVENTION

1. Field of the Invention

Apparatuses and methods consistent with the present invention relate to acquiring identification information when a bus reset occurs. More particularly, the present invention relates to an apparatus and a method for acquiring the new identification information (e.g., a PHY ID), when a bus reset occurs in slave devices existing in an IEEE 1394 A/V network by regulating the power source state of the slave devices.

2. Description of the Related Art

IEEE 1394, known as “Firewire”, is a serial bus interface standard proposed jointly by Apple Computer, Inc. and Texas Instruments Incorporated. Firewire development began in 1986, and it was officially standardized as IEEE 1394 in December 1995 by the Institute of Electrical and Electronics Engineers (IEEE).

IEEE 1394 is the next generation multimedia interface technology capable of exchanging information between various multimedia devices according to the specification established by the IEEE. Especially, it is a serial bus standard capable of sending and receiving data between next generation multimedia devices, and it is a improvement over existing interface technologies which only allow the connection between a personal computer and peripheral devices (e.g., a mouse, a printer, or a scanner). As a serial bus standard, IEEE 1394 consists of simple protocols for data transfer. IEEE 1394 merely provides a means for data transfer, and therefore, in order for it to be used as a medium to connect networks there should be various network functions in the upper layer.

FIG. 1. is a block diagram illustrating the general protocol structure of IEEE 1394. As illustrated, IEEE 1394 includes three protocol layers. A serial bus management is connected to a physical layer (PHY), a link layer (LINK), and a transaction layer. Also, the physical layer is connected to an IEEE 1394 connector, and other layers are connected to the application.

The physical layer is electrically connected to an IEEE 1394 device and a cable, and plays the role of a repeater that provides the same functions to each port, sends and receives real data, and executes all device buses in order.

The link layer includes two sending FIFO (First In First Out) queues and one receiving FIFO queue in order to send and receive asynchronous and isochronous transmission packets. The length of each FIFO queue is 32 bits, and a user can determine the size of the FIFO queue using software. The isochronous FIFO queue and the asynchronous FIFO queue, which are dedicated to sending, are used for writing, and the FIFO queue dedicated to receiving is used for reading. The asynchronous transmission sends data and layer information to the specified address, and is used in situations where real time data transmission is not required. The isochronous transmission does not use addresses when sending data, but includes channel numbers for transmission.

In other words, even though errors are made, retransmission is not requested. This isochronous transmission is used when multimedia data having temporal limitations, such as moving pictures and audio information, is transmitted.

The transaction layer performs the reading, writing and locking functions of the asynchronous protocol. The writing function transmits data from the sending side to the receiving side, and the reading function transmits data to the sending side. The locking function is a combined function of writing and reading orders. If communication is in progress between the receiving side and the sending side, the locking function retransmits after the communication prior to the other sending side is completed.

The serial bus management regulates timing, provides power to all devices, manages all serial buses, and grants the roles of cycle master, isochronous ID, error recognition, and others to each layer. Bus management uses the IEEE 1212 standard register structure.

By these protocols and the IEEE 1394 interface, new peripheral devices are added to the network, or when a device becomes separated from the network, the network is readjusted. At this time, all existing information is initialized, and the whole network is dynamically reconstructed, and each node is re-granted an address.

In the above situation, if the root node is necessary, the most often-used node can be forcibly specified as the root node. After a root node is determined, so each node informs other nodes its existence over the network (self-recognition). In this way, information on all nodes is collected, and the IEEE 1394 interface goes into a standby state.

FIGS. 2A and 2B are block diagrams illustrating the structure of an IEEE 1394 A/V device.

As illustrated, the IEEE 1394 A/V device includes a main processing unit including a CPU and memory, an IEEE 1394 controller unit for handling IEEE 1394 communication, and a peripheral device unit for handling audio/video signals and data storage (hard disk). Here, the IEEE 1394 master device, as the main body that remotely controls the power, refers to a TV. The IEEE 1394 slave device, as a device controlled by the master device, refers to an AV-HDD DVD STB, VCR, AV-Receiver, or others.

The operation of an A/V device can be explained using two cases: a case not using 1394 link-on packets (i.e., using power-on instruction of the upper layer protocols), and a case using 1394 link-on packets.

First, the case where an A/V device does not use IEEE 1394 link-on packets is explained by referring to FIG. 2A.

The IEEE 1394 master device transmits the power-on instruction to the IEEE 1394 slave device using IEEE 1394 upper layer protocols such as AV/C and HTTP. Here, the power-on instruction is transmitted by the 1394 controller unit to the main processing unit, and when the main processing unit turns the peripheral device unit on, the slave device is powered on.

But, because the power-on instruction is transmitted using the IEEE 1394 upper layer protocols such as AV/C and HTFP, the main processing unit including the CPU and memory, and the 1394 link chip should be running to handle this instruction (gray blocks signify modules that were powered-on). In other words, because the main processing part is operated even in the power-off state of the A/V device, significant power is consumed even in the power-off state, which is a problem.

Next, referring to FIG. 2B, the case where an A/V device uses IEEE 1394 link-on packets is explained.

If the 1394 master device transmits the link-on packets (defined in IEEE 1394a) to the 1394 slave device, the 1394 PHY chip of the slave device that received link-on packets turns on the power of the 1394 link chip and the main processing unit.

Then, the main processing unit turns the power of the peripheral device unit on again, and the slave device is fully powered-on.

For example, if link-on packets are used, only 1394 PHY is operated in the slave device when the power is turned off (gray blocks are modules where the power is on). After that, the 1394 PHY chip of the slave device that received link-on packets turns its power on. In other words, because only 1394 PHY is operated when the power is off, not much power is consumed.

However, link-on packets are transmitted using a 1394 PHY identification (ID) (i.e., the unique device ID that devices of the IEEE 1394 bus have), and a new 1394 PHY ID is allocated whenever a 1394 bus reset occurs.

In other words, if a new device is connected to the 1394 bus, or a connected device is disconnected, the IEEE 1394 bus senses this, and executes the bus reset process. At this point, the newly-allocated PHY ID can be the same PHY ID as the prior PHY ID, or it can be different PHY ID. Since only the 1394 PHY operates in the slave device, the master device cannot be informed of the newly-allocated PHY ID, which is a problem.

So, because the PHY ID can be changed whenever a bus reset occurs, if the master device tries to control the slave device, a problem can occur where the link-on packets are sent to the slave devices having the prior PHY ID.

For example, it is assumed that there is a TV, DVD player, and NIU (Network Interface Unit), and the PHY ID of the TV is 2, the PHY ID of the DVD is 1, and the PHY ID of the NIU is 0.

After that, if a bus reset occurs because of the new connection of the AV-HDD, a new PHY ID is allocated. In other words, the PRY ID of TV becomes 3, the PHY ID of the AV-HDD becomes 0, the PHY ID of the DVD becomes 2, and the PHY ID of the NIU becomes 1.

After that, if link-on packets are sent to the unit having the PHY ID (that is, PHY ID=0) in order for the TV to turn the power of the NIU on, a wrong operation is performed in that AV-HDD is linked on.

Accordingly, there is a need for a technology that can accurately control and manage the slave device using a new PHY ID.

### SUMMARY OF THE INVENTION

In order to solve the above-described problems, an aspect of the present invention is to control a desired slave device without an error by acquiring the new identification information (e.g., a PHY ID) by adjusting the power state of a slave device when a bus reset occurs in slave devices existing in an IEEE 1394 A/V network.

Also, another aspect of the present invention is to reduce the power consumption by changing the power state to the power-standby state after acquiring the basic information of the slave device by changing the power state of slave devices existing in an IEEE 1394 A/V network.

The present invention will not be limited to the technical aspects described above. Other aspects not described herein will be more definitely understood by those in the art from the following detailed description.

According to an exemplary embodiment of the present invention, there is provided a master device comprising a reset check unit which checks the reset in slave devices existing in an A/V network, a packet generation unit which generates information request packets requesting basic information and link-on packets requesting to turn link units on when a reset of the slave device occurs, and a PHY unit which transmits the generated link-on packets and information request packets.

According to another exemplary embodiment of the present invention, there is provided a slave device comprising a PHY unit which receives the instruction packets transmitted from the master device existing in an A/V network, a power control unit which checks the state of power corresponding to the received instruction packet and which controls the authorization of power according to the checked state of power, and an information retrieval unit which retrieves the saved basic information if the received instruction packet is an information request packet.

According to an exemplary embodiment, there is provided a method for acquiring identification information when a bus reset occurs, comprising checking the reset in slave devices existing in an A/V network, transmitting link-on packets to the slave devices when a reset occurs as a result of the checking, transmitting an information request packet to the slave devices when the state of power of the slave devices is changed into the power-up state as the link-on packets are transmitted, receiving basic information of the slave devices as a response to the information request packet, and writing a mapping table, based on the basic information of the received slave devices.

According to another exemplary embodiment of the present invention, there is provided a method for acquiring identification information when a bus reset occurs, comprising receiving link-on packets from a master device existing in an A/V network, changing the state of power according to the received link-on packets, retrieving basic information of slave devices according to the information request, and transmitting the retrieved basic information to the master device.

### BRIEF DESCRIPTION OF THE DRAWINGS

The above aspects and other features and advantages of the present invention will become more apparent by describing in detail exemplary embodiments thereof with reference to the attached drawings in which:

FIG. 1 illustrates the structure of general IEEE 1394 protocols.

FIGS. 2A and 2B illustrate a structure of an IEEE 1394 A/V device.

FIG. 3 illustrates a system having a device which acquires identification information when a bus reset occurs according to an exemplary embodiment of the present invention.

FIG. 4 is a block diagram illustrating the inside of a master device acquiring identification information when a bus reset occurs according to an exemplary embodiment of the present invention.

FIG. 5 is a block diagram illustrating the inside of a slave device controlled by a device acquiring identification information when a bus reset occurs according to an exemplary embodiment of the present invention.

FIG. 6 illustrates link-on packets generated by the packet generation unit of a device which acquires identification information when a bus reset occurs according to an exemplary embodiment of the present invention.

FIG. 7 is a table illustrating the state of power according to a an exemplary embodiment of the present invention.

FIG. 8 is a flow chart illustrating the process of operation when the power of the master device is on for acquiring identification information when a bus reset occurs according to an exemplary embodiment of the present invention.

FIG. 9 is a flow chart illustrating the process of operation when the power state of the master device is changed from off to on for acquiring identification information when a bus reset occurs according to an exemplary embodiment of the present invention.

FIG. 10 is a flow chart illustrating the operation of a slave device for acquiring identification information when a bus reset occurs according to an exemplary embodiment of the present invention.

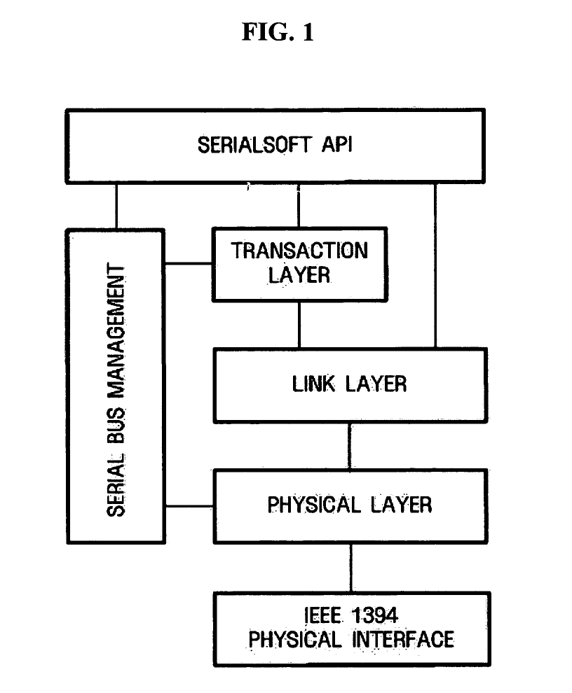

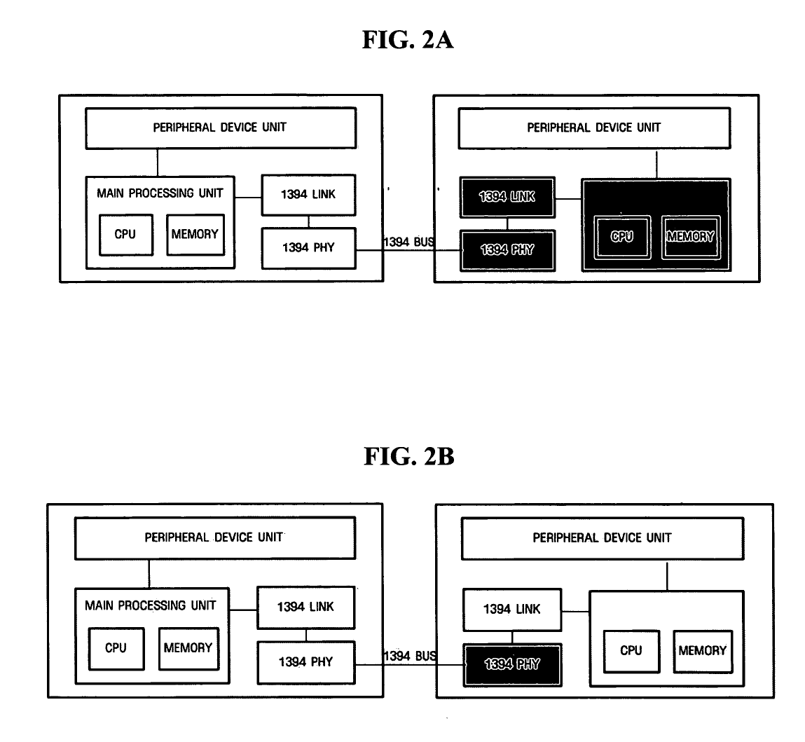

### DETAILED DESCRIPTION OF EXEMPLARY EMBODIMENTS

Various aspects and features of the exemplary embodiments of the present invention will be covered by the detailed description and accompanying drawings.

Advantages and features of the present invention and methods of accomplishing the same may be understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Hereinafter, the present invention is explained, by referring to drawings showing block diagrams or flow charts that explain a device and a method that acquires identification information when a bus reset occurs according to exemplary embodiments of the present invention. Each block of flow charts and combination of flow charts can be executed by computer program instructions. Because the computer program instructions can be executed in the processor of a general-purpose computer, special-purpose computer or other programmable data processing equipment, the instructions executed via the computers or other programmable data processing equipment generate a means for executing the functions explained in the flow chart blocks of flow charts. Because it is possible for the computer program instructions to be saved in computer-usable or computer-readable memories in order to implement functions in certain ways, the instructions saved in the computer-usable or computer-readable memories can produce items containing the instruction means for performing the functions explained in the flow chart blocks. Also, each block can represent a part of a module, or a segment of code that includes one or more executable instructions for executing specific logical functions. Further, it should be noted that functions mentioned in the blocks can be executed out of order.

For example, the illustrated two adjacent blocks can be practically executed at the same time, and the blocks sometimes can be executed in reverse order according to the concerned functions.

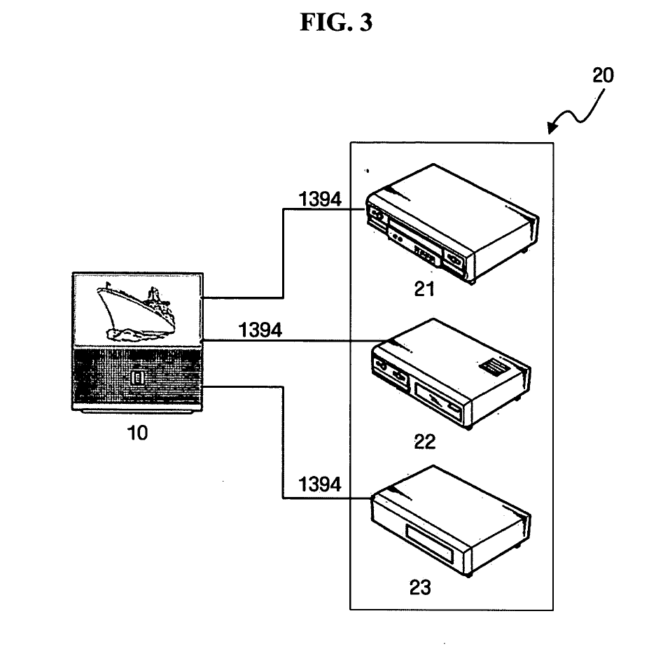

FIG. 3 illustrates a system having a device for acquiring identification information when a bus reset occurs according to an exemplary embodiment of the present invention.

As illustrated, a master device 10 and a slave device 20 including several slave devices 21, 22, and 23 exist in an IEEE 1394 A/V network. The master device 10 and slave devices 21, 22, and 23 are connected by a communication control line using a separate protocol for data packet transmission (e.g., an IEEE 1394 connection line).

Through the communication control line, basic information of devices existing in an A/V network (e.g., identification information and device information) and connection state information, and others can be sent and received, and operation instructions for controlling slave devices 21, 22, and 23 can also be transmitted.

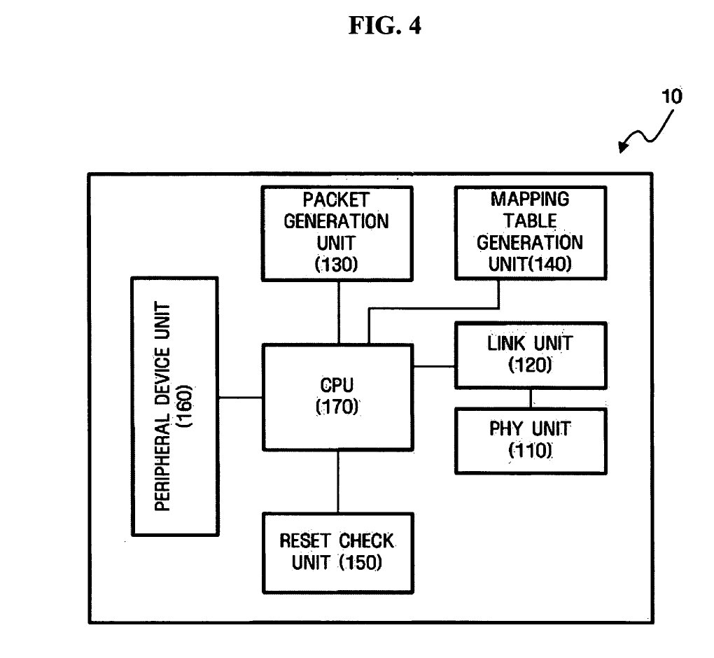

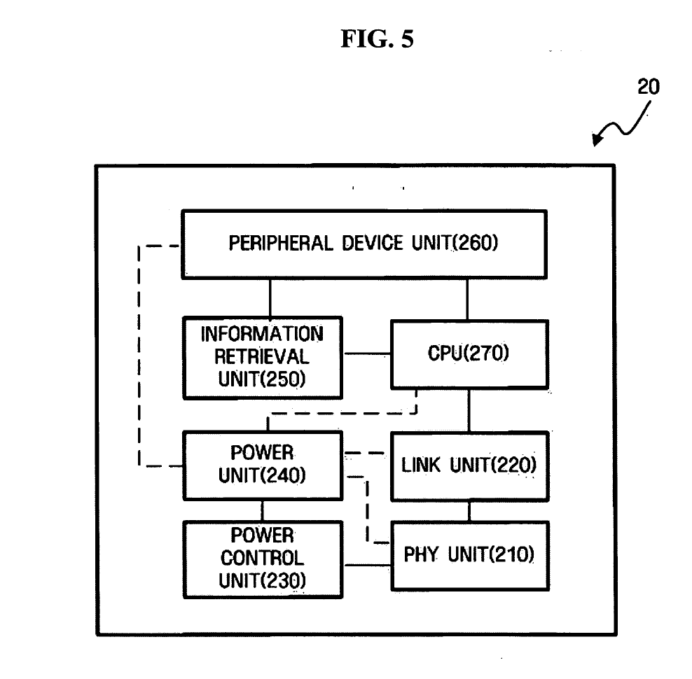

At this time, the master device 10 transmits a power-on instruction to the slave device 20 using link-on packets. Then, power is only applied for the PHY unit of the slave device 20; it is not applied for other modules (e.g., a link unit or a CPU). So the power consumed by the slave device 20 in the power-off of can be reduced. Hereinafter, the master device 10 and the slave device 20 are explained in detail by referring to FIG. 4 and FIG. 5.

FIG. 4 is a block diagram illustrating the inside of the master device for acquiring the identification information when a bus reset occurs according to another exemplary embodiment of the present invention.

As illustrated, the master device 10 comprises a PHY unit 110, a link unit 120, a packet generation unit 130, a mapping table generation unit 140, a reset check unit 150, a peripheral device unit 160, and a CPU.

At this time, the term “unit” used in this exemplary embodiment refers to a hardware element, FPGA or an ASIC, and the “unit” executes certain roles. But the “unit” is not limited to software or hardware. The “unit” can reside in an addressable storage media or can reproduce one or more processors. For example, a “unit” can include software objects, object-oriented software objects, class objects, task objects, processes, functions, attributes, procedures, circuits, data, database, data structures, tables, arrays, variables, etc. Units and functions can be combined to form fewer units and functions, or they can be further divided into additional units and functions. Furthermore, units and functions can be implemented to reproduce one or more CPUs in a device or a security multimedia card.

The PHY unit 110 sends and receives data packets, and transmits an instruction packet generated by a packet generation unit 130 (e.g., a link on/off packet, or an information request packet) to the slave device 20. Also, the PHY unit 110 receives a response packet transmitted by the slave device 20.

The link unit 120 transmits a response packet received by the PHY unit 110 to the CPU 170, and transmits an instruction packet transmitted by the CPU 170 to the PHY unit 110.

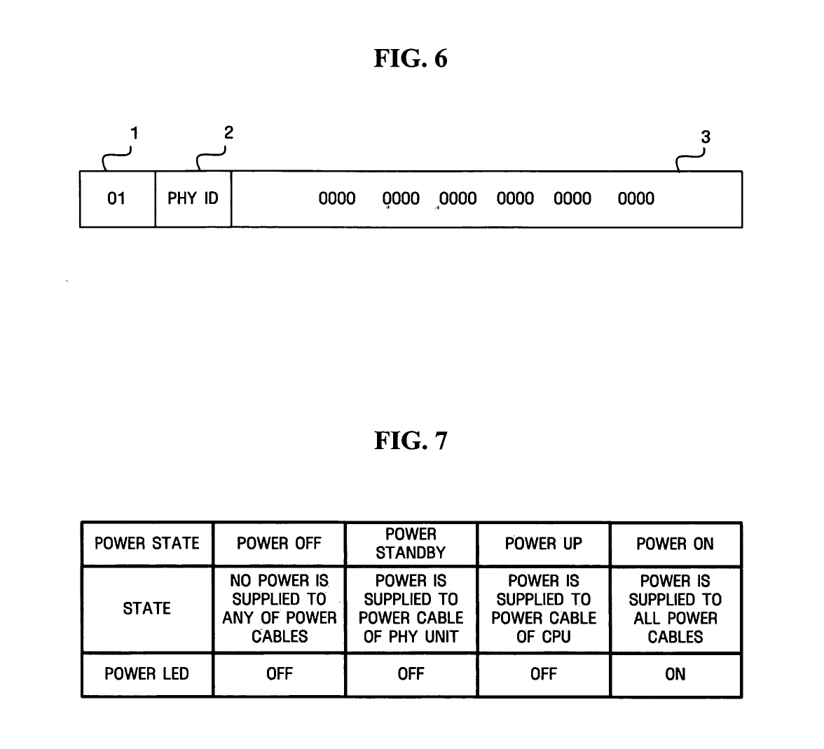

When a reset of the slave device 20 occurs or a certain slave device 20 is to be controlled, the packet generation unit 130 records a link-on packet instructing turn on of the link unit 120, generates an information request packet requesting the basic information and transmits this packet to the slave device 20. Hereinafter, a link-on packet is explained by referring to FIG. 6.

As illustrated in FIG. 6, a link-on packet comprises a field 1 for recording an instruction value (i.e., 01) to instruct turn on of the link unit 120, a field 2 for recording the PHY ID of the concerned slave device 20, and a field 3 for data. The field 3 is empty, and it exists so that the packet conforms to the format of a general packet.

Also, the packet generation unit 130 analyzes a response packet received from the slave device 20 by the PHY unit 110, and extracts the basic information of the concerned slave device 20. The basic information includes the device name, the device UI, the device type, and the device function.

The mapping table generation unit 140 generates a mapping table based on the basic information of the slave device 20, which is extracted by the packet generation unit 130. The mapping table saves the identification information and device information by slave devices. Also, the mapping table is updated whenever a bus reset occurs.

The reset check unit 150 checks for a reset in slave devices existing in an A/V network. Particularly, the reset refers to the additional connection of new devices to a 1394 bus, and the allocation of a new PHY ID when a connected device is separated.

Meanwhile, when a reset occurs, if the power of the master device 10 is on (power-on state), the reset check unit 150 can directly check the newly-allocated PHY ID. If the power of the master device 10 is off (power-standby state), the reset cannot be checked. So, after the master device 10 is powered on, the reset check unit 150 checks the reset through a PHY unit 11.

For example, it is assumed that three devices: TV, DVD player, and a STB exist in the A/V network. At this time, if an AV-HDD connects to the network, the A/V network now has 4 devices, then a new PHY ID is allocated to each device (e.g., a TV, DVD player, STB and AV-HDD). During this time, each device can be allocated the same ID as the prior PHY ID, or a different ID. If a bus reset occurs, one device among devices existing in the A/V network is selected as a bus master, and the selected bus master allocates a new PHY ID to each of the remaining devices of the A/V network.

If the CPU 170 is operating, the reset check unit 150 can check the slave devices 21, 22, and 23 for the occurrence of a reset by looking for a reset signal received through the PHY unit 110. If the CPU 170 is not operating, i.e., if the occurrence of a reset in slave devices 21, 22, and 23 is not recognized at the moment the master device 10 is turned on, i.e., when the CPU 170 starts operating, the reset occurrence can be recognized by checking the PHY unit 110.

For example, a reset can be checked by checking the register of the PHY unit 110, or the reset can be checked by saving the concerned value when the PHY unit 110 receives a reset signal. The method for checking the reset (explained above) is an exemplary embodiment, and it should not be construed as being limited to the exemplary embodiment.

The peripheral device unit 160 includes all input/output devices and memory units connected to the CPU 170 in the master device 10, which handle audio/video signals or save data (hard disk).

The CPU 170 controls the general operation of the master device 10. If a reset occurs in a slave device 20, the CPU 170 controls the packet generation unit 130 to generate a link-on packet. The generated link-on packet is broadcasted to all slave devices 21, 22, and 23 existing in the A/V network.

Also, if the CPU of slave devices is operated through the link-on packet, the CPU 170 controls the packet generation unit 130 to generate an information request packet, and transmits the generated information request packet to all slave devices 21, 22, and 23 existing in the A/V network.

Next, if the response packet having the basic information is received from the slave device 20 through the PHY unit 110, the CPU 170 controls the packet generation unit 130 to analyze the response packet, and transmits extracted basic information to the mapping table generation unit 140. Then, the mapping table generation unit 140 is controlled to generate a mapping table based on the basic information about the slave device 20.

Further, if a mapping table is generated, the CPU 170 generates a link-off packet, and broadcasts the packet to slave devices 21, 22, and 23. So, because only the PHY unit of slave devices 21, 22, and 23 is operated, power consumption can be reduced.

Therefore, if a reset occurs in a slave device, the master device 10 transmits the link-on packet to all slave devices 21, 22, and 23, requests basic information from each slave device, and receives a PHY ID and new device information. Then, a mapping table is generated based on the provided PHY ID and device information so that the slave device executing the prescribed operation can be accurately controlled.

FIG. 5 is a block diagram illustrating the inside of a slave device that is controlled by a master device that acquires the identification information when a bus reset occurs according to another exemplary embodiment of the present invention.

As illustrated, a slave device comprises a PHY unit 210, a link unit 220, a power control unit 230, a power unit 240, an information retrieval unit 250, a peripheral device unit 260, and a CPU 270.

A PHY unit 210 receives an instruction packet transmitted by the master device 10 existing in the A/V network and transmits the basic information of the slave device 20 retrieved by the information retrieval unit 250. The instruction packet refers to a link on/off packet and an information request packet, and the basic information refers to the identification information of the slave device (e.g., a PHY ID) and the device information (e.g., the device name, the device UI, the device type, and the device function).

The link unit 220 transmits the instruction packet received by the PHY unit 210 to the CPU 270, and transmits the response packets transmitted by the CPU 270 to the PHY unit 210.

The power control unit 230 checks the power state for the instruction packet received by the PHY unit 210, and controls the power applied accordingly. The power state comprises a power-off state, power-standby state, power-up state, and power-on state.

Also, the power state shows the power lines, as illustrated by dotted lines in FIG. 5, of the slave device 20. The supply of power is explained in the following by referring to FIG. 7.

As illustrated in FIG. 7, the power-off state is the state where the power cable is connected, but the supply of power is not applied. It refers to the state where the slave device 20 is not in operation.

Also, the power-standby state is the state where the power is applied to only the power cable connected to the PHY unit 210. The power-up state is the state where the power is applied to the power cable connected to the link unit 220 and the CPU 270 by the transmission of the link-on packet by the master device 10.

Additionally, the power-on state is the state where the power is applied not only to the link unit 220 and CPU 170 but also to the peripheral device unit 260 by the transmission of the power-on instruction packet by the master device 10. In other words, it is the state where the slave device 20 executes the prescribed operation.

Meanwhile, if a link-off packet is received from the master device, the slave device goes into the power-standby state.

The power unit 240 supplies power to the power cable according to the power authorization instruction of the power control unit 230. In other words, the power cable is turned on/off by the power control unit 230 instructions.

For example, if a power-standby instruction is transmitted from the power control unit 230, the power cable of the PHY unit 210 is turned on, and if a power-up instruction is transmitted, the power cable of the PHY link unit 220 and CPU 270 is turned on (i.e., the power of PHY unit 210 is in the “on” state). Also, if an instruction of the power-on state is transmitted, the power cable of the peripheral device unit 260 is turned on (i.e., the power of PHY unit 210, link unit 220 and CPU 270 is in the “on” state).

The information retrieval unit 250 retrieves basic information if the instruction packet transmitted from the master device 10 is an information request packet. Basic information refers to the identification information of the slave device (e.g., a PHY ID) and the device information (e.g., device name, device ID, device type and device function).

The peripheral device unit 260 includes all input/output devices and memory units connected to CPU 270 in the slave device 20, which handles audio/video signals or saves data (hard disk).

The CPU 270 controls the general operation of the slave device 20, and executes the prescribed operation if an instruction packet is received from the master device 10.

For example, after power is applied to the link unit 220 and the CPU 270 by the reception of a link-on packet by the PHY unit 210, if an information request packet is received, the basic information is retrieved by controlling the information retrieval unit 250.

Also, the CPU 270 controls the peripheral device unit 260 to execute the prescribed operation according to the operation instruction packet of the master packet 10.

Therefore, the slave device 20 receives the prescribed instruction packet from the master device 10 through the PHY unit 210, and is operated according to the received packet. For example, if a link-on packet is received from the master device 10, the power control unit 230 authorizes power to the link unit 220 and the CPU 270, and if an information request packet is received, basic information is provided through the CPU. In this way, the master device 10 can accurately control the slave device 20.

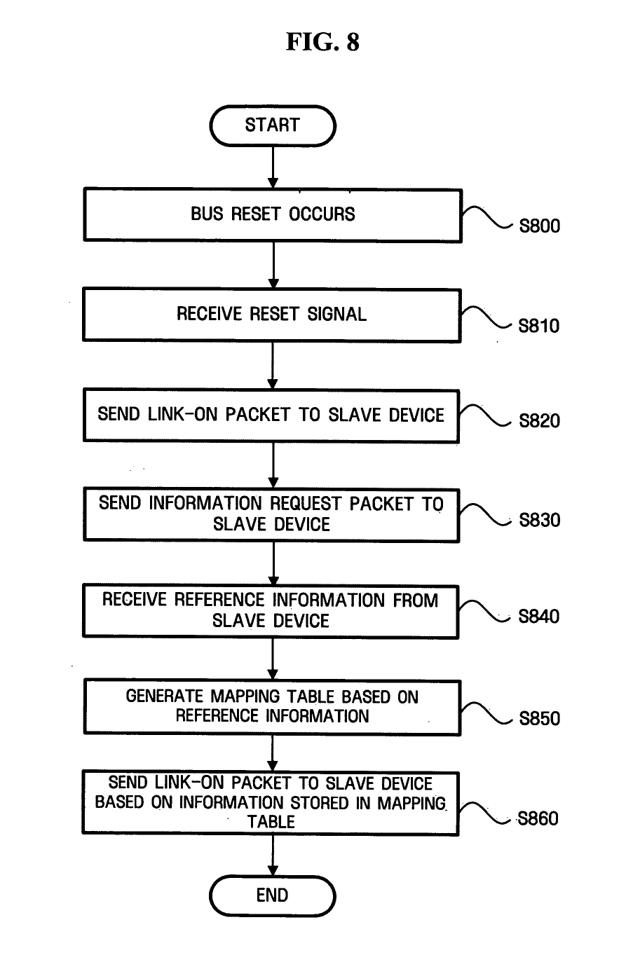

FIG. 8 is a flow chart illustrating the power-on operation of the master device for acquiring the identification information when a bus reset occurs according to an exemplary embodiment of the present invention.

First, if an IEEE 1394 bus reset occurs, the PHY unit 110 of the master device receives the reset generation signal, and a new PHY ID from the bus master device (not shown) (S800 and S810). The reset may be caused by a new device connecting to the IEEE 1394 bus, or by the allocation of a new PHY ID if a connected device is separated from the bus.

At this time, if the power of the master device 10 is on, the CPU 170 can directly recognize that the IEEE 1394 bus reset has occurred through the new PHY ID received by the PHY unit 110.

Next, the CPU 170 of the master device 10 generates the link-on packet by controlling the packet generation unit 130, and broadcasts the generated link-on packet to the slave device 20 (S820). The master device 10 transmits the link-on packet to the slave device 20 to request the new identification information of the slave device (i.e., a PHY ID) after the power state of the slave device 20 changed to the power-up state.

Then, if the CPU 270 of the slave device 20 is operated, the master device 10 generates a basic information request packet of the slave device 20, and transmits the generated information request packet to the slave device 20 (S830). The master device 10 requests basic information from the slave device 20 to recognize slave devices existing in the A/V network.

Next, if a response packet is transmitted by the slave device 20, the packet generation unit 130 analyzes the transmitted response packet, and extracts the basic information of the slave device 20 (S840). The basic information refers to the identification information (e.g., a PHY ID) and device information (e.g., device name, device UI, device type and device function).

Then, the mapping table generation unit 140 generates mapping table mapping identification information and device information by slave devices 20 based on the extracted basic information (S850).

Meanwhile, if a mapping table has been created, the master device 10 changes the power state of slave devices into the power-standby state by transmitting a link-off packet to slave devices 21, 22, and 23. Consequently, because power is applied to only the PHY unit 210 of the slave device, a power loss does not occur.

Next, if the master device 10 is to control the prescribed slave device 20, a link-on packet is transmitted to a slave device 20 based on the identification information (i.e., a PHY ID) of the slave device saved in the mapping table (S860).

Therefore, if a bus reset occurs, the master device 10 is provided with the new identification information (e.g., a PHY ID) according to the adjusted power state of the slave device 20 from respective slave devices 21, 22, and 23, and it then saves a mapping table. Subsequently, if operation of the slave device 20 is to be controlled, the respective slave device can be operated using the information saved in the mapping table.

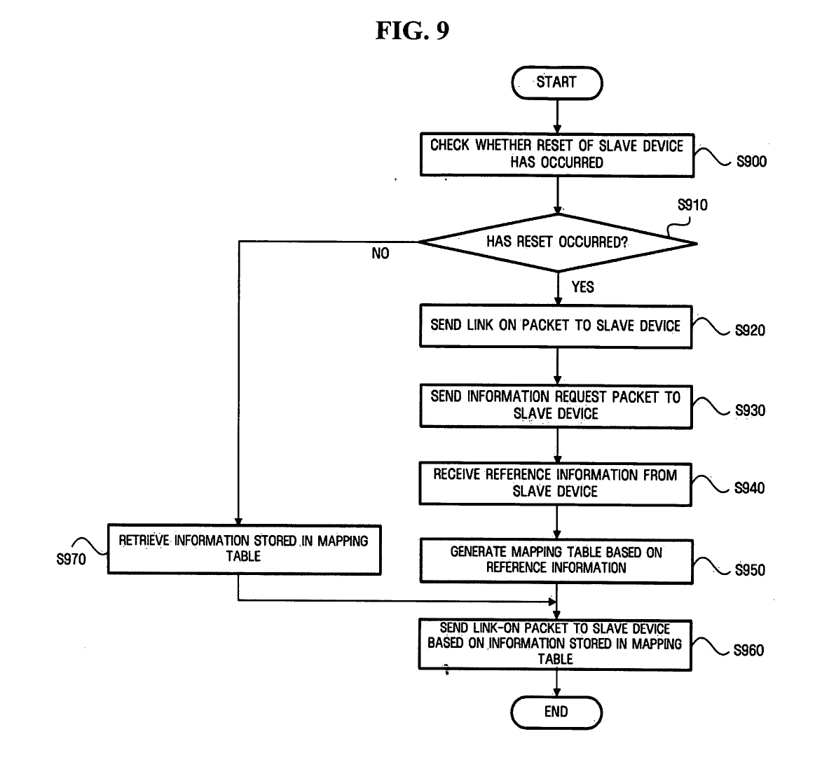

FIG. 9 is a flow chart illustrating the operation of the master device when the power state is changed from off to on for acquiring the identification information when a bus reset occurs according to an exemplary embodiment of the present invention.

First, when the power state of the master device 10 is changed from off to on, the CPU 170 checks for a reset of the IEEE 1392 bus through the reset check unit 150 (S900). The reset refers to connection of a new device to the 1394 bus or the new allocation of a new PHY ID if a connected device becomes separated from the bus.

At this time, when the power state of the master device 10 is changed from off to on, because the reset of the IEEE 1394 bus cannot be recognized, whether the reset occurred is checked through the reset check unit 150 if the power is turned on and the CPU 170 starts to operate. The reset check unit 150 can check the reset of the 1394 bus by checking the register of the PHY unit 110.

As a result of the checking, if a reset occurred (S910), the CPU 170 of the master device 10 generates link-on packets by controlling the packet generation unit 130, and broadcasts the generated link-on packets to the slave device 20 (S920). Hereinafter, operations S930 to S960 are the sane as operations S830 to S860 of FIG. 8, and therefore, a detailed explanation is omitted.

Meanwhile, as a result of the checking, if a reset did not occur (S910) because the PHY ID of the slave device 20 did not change, the processes from the step S930 to the step S950 are not executed. Next, if the master device 10 is to control the slave device 20, the CPU of the master device 10 can retrieve the PHY ID of the respective slave device 20 by using the mapping table created in advance (S970), and the link-on packet is transmitted through the retrieved PHY ID based on the identification information of the slave device saved in the mapping table (S960).

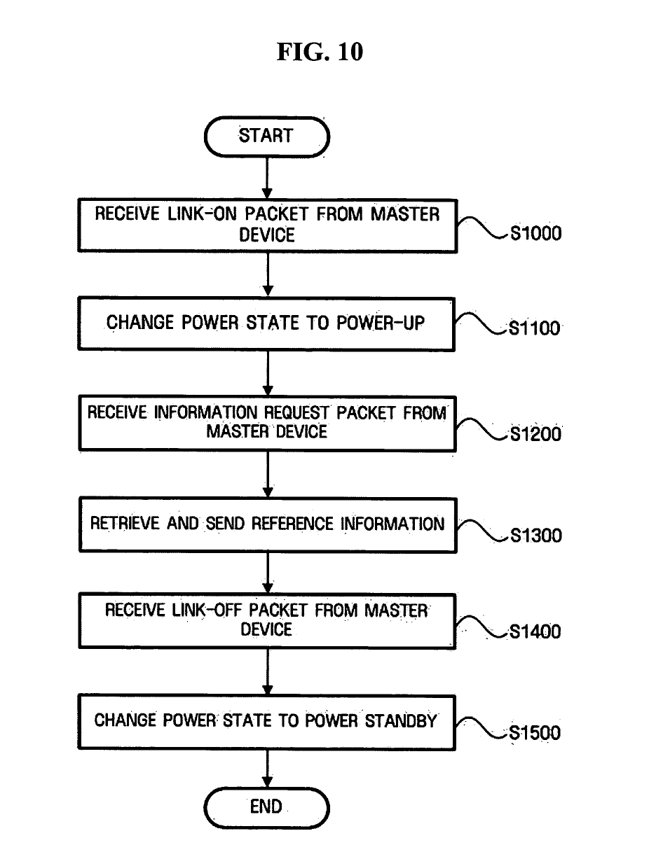

FIG. 10 is a flow chart illustrating the operation of a slave device for acquiring the identification information when a bus reset occurs an exemplary embodiment of the present invention.

First, if the PHY unit 210 of the slave device 20 receives a link-on packet from the master device 10 (S1000), the PHY unit 210 transmits the received link-on packet to the power control unit 230.

Next, the power control unit 230 changes the power state from the power-standby state to the power-up state (S1100), and transmits this change to the power unit 240. Thus, the power control unit 240 authorizes power to the power cable of the link unit 220 and the CPU 270.

Then, if an information request packet is received from the master device 10 (S1200), the CPU 270 controls the information retrieval unit 250 to retrieve basic information. Therefore, the information retrieval unit 250 retrieves the basic information, and transmits it to the master device 10 via the PHY unit 210 (S1300).

After that, if a link-off packet is transmitted from the master device 10 and received by the slave device (S1400), the power control unit 230 of the slave device changes the power state into the power-standby state (S1500), and therefore the power unit 240 does not authorize power to the power cable of link unit 220 and CPU.

Therefore, if the link-on packet of the master device 10 is received, the slave device 20 changes the power state into the power-up state, and then retrieves and provides basic information according to the request from the master device. After that, the slave device 20 receives the link-off packet from the master device, and can reduce power consumption as the power state is changed to the power-standby state.

It will be understood by those of ordinary skill in the art that various replacements, modifications and changes may be made in the form and details without departing from the spirit and scope of the present invention as defined by the following claims. Therefore, it is to be appreciated that the above described embodiments are for purposes of illustration only and are not to be construed as limitations of the invention.

What is claimed is:

1. A master device comprising:
a reset check unit which determines whether a reset occurs in a slave device existing in a network;
a packet generation unit which generates an information request packet requesting basic information and a link-on packet instructing turn on of a link-on unit if it is determined that the reset occurs in the slave device; and
a physical layer (PHY) unit which sends the generated link-on packet and the information request packet.

2. The device of claim 1, wherein the basic information comprises identification information and device information of the slave device.

3. The device of claim 1, further comprising a mapping table generation unit which writes a mapping table based on the basic information of the slave device transmitted as a response to the information request packet.

4. A slave device comprising:
a physical layer (PHY) unit which receives an instruction packet transmitted by a master device existing in an A/V network;
a power control unit which checks a power state for the received instruction packet and controls an authorization of the power according to the power state; and
an information retrieval unit which receives saved basic information if the received instruction packet is an information request packet.

5. The device of claim 4, wherein the power state is one of a power-off state, a power-standby state, a power-up state and a power-on state.

6. The device of claim 4, wherein the basic information comprises identification information and device information of the slave device.

7. A method for acquiring identification information when a bus reset occurs, the method comprising:
determining whether a reset occurs in a slave device in a network;
transmitting a link-on packet to the slave device if it is determined that the reset occurs;
transmitting an information request packet to the slave device if a power state of the slave device is changed into a power-up state as the link-on packet is transmitted;
receiving the basic information of the slave device as a response to the information request packet; and
writing a mapping table based on the received basic information of the slave device.

8. The method of claim 7, wherein the basic information comprises identification information and device information of the slave device.

9. The method of claim 7, further comprising changing the power state of the slave device to a power-standby state at the time of completion of writing the mapping table.

10. A method for acquiring identification information when a bus reset occurs, the method comprising:
receiving a link-on packet from a master device existing in a network;
changing to a power state according to the received link-on packet;
retrieving a basic information of a slave device according to an information request if the information request is received from the master device; and
sending the retrieved basic information to the master device.

11. The method of claim 10, wherein the power state is one of a power-off state, a power-standby state, a power-up state and a power-on state.

12. The method of claim 10, wherein the basic information refers to identification information and device information of the respective slave devices.
